(19) United States
(12) Patent Application Publication
(10) Pub. No.: US 2018/0286352 A1
(43) Pub. Date: Oct. 4, 2018

(54) INFORMATION DISPLAY METHOD AND HEAD-MOUNTED DISPLAY

(71) Applicant: Lenovo (Beijing) Co., Ltd., Beijing (CN)

(72) Inventors: Cen YAO, Beijing (CN); Xi WAN, Beijing (CN)

(21) Appl. No.: 15/938,282

(22) Filed: Mar. 28, 2018

(30) Foreign Application Priority Data
Mar. 28, 2017 (CN) 201710192275.3

(51) Int. Cl. G09G 5/14; G06F 3/14; G09G 5/00; G09G 5/34; G06F 3/0485; G06F 3/0484; G06T 11/60; G02B 27/01

(52) U.S. Cl. CPC G09G 5/14; G06F 3/1423; G09G 5/003; G09G 5/34; G06F 3/0485; G02B 2027/014; G06T 11/60; G02B 27/0172; G09G 2354/00; G09G 2340/045; G06F 3/04845

(57) ABSTRACT

An information display method, a head-mounted display, and a terminal device are provided. The information display method includes detecting an input operation for switching from a first display mode, for displaying a first display content through a display screen of the terminal device, to a second display mode, for displaying a second display content containing at least a portion displayed through the head-mounted device. The first display content and second display content correspond to a same source content. The information display method also includes in response to detecting the input operation, displaying the second display content at least partially through the head-mounted device.

### CROSS-REFERENCES TO RELATED APPLICATIONS

This application claims the priority of Chinese patent application No. 201710192275.3, filed on Mar. 28, 2017, the entirety of which is incorporated herein by reference.

### FIELD OF THE DISCLOSURE

The present disclosure generally relates to the field of augmented reality technology and, more particularly, relates to an information display method, a head-mounted display and a terminal device.

### BACKGROUND

Augmented reality (AR) is an emerging technology that uses a computer system to generate three-dimensional information to enhance user's perception of the real world. Recently, an AR glass, an emerging product having an independent operating system as a smart phone, can be installed with software, games and other programs provided by software providers. Various functions, such as calendar, map navigation, interaction with friends, taking pictures and videos, and starting a video call with friends, etc., can be added on the AR glass through a voice or action control. The AR glass can access to a wireless network through a mobile communication network.

### BRIEF SUMMARY OF THE DISCLOSURE

One aspect of the present disclosure includes an information display method. The method includes detecting an input operation for switching from a first display mode, for displaying a first display content through a display screen of the terminal device, to a second display mode, for displaying a second display content containing at least a portion displayed through the head-mounted device. The first display content and second display content correspond to a same source content. The information display method also includes in response to detecting the input operation, displaying the second display content at least partially through the head-mounted device.

Another aspect of the present disclosure includes a head-mounted display. The head-mounted display includes a processor, a data receiver, and a lens. The processor is configured to detect an input operation for switching from a first display mode, for displaying a first display content through a display screen of a terminal device, to a second display mode, for displaying a second display content containing at least a portion displayed through the head-mounted display. The first display content and second display content correspond to a same source content. The data receiver is configured to receive the source content from the terminal device, in response to the processor detecting the input operation. The lens is configured to view at least the portion of the second display content, in the second display mode.

Another aspect of the present disclosure includes a terminal device. The terminal device includes a display screen, a processor, and a data transmitter. The processor is configured to detect an input operation for switching from a first display mode, for displaying a first display content through the display screen, to a second display mode, for displaying a second display content containing at least a portion displayed through a head-mounted display. The first display content and second display content correspond to a same source content. The data transmitter is configured to transmit the source content to the head-mounted display, in response to the processor detecting the input operation.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a flow chart of an information display method consistent with some embodiments of the present disclosure;

FIG. 2 illustrates a schematic diagram of an application scenario of an information display method consistent with some embodiments of the present disclosure;

FIG. 3 illustrates a schematic diagram of an example of an information display method consistent with some embodiments of the present disclosure;

FIG. 4 illustrates a schematic diagram of another example of an information display method consistent with some embodiments of the present disclosure; and

FIG. 5 illustrates a schematic diagram of a head-mounted display consistent with some embodiments of the present disclosure.

### DETAILED DESCRIPTION

Reference will now be made in detail to various embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

The disclosed embodiments in the present disclosure are merely examples for illustrating the general principles of the invention. Any equivalent or modification thereof, without departing from the spirit and principle of the present invention, falls within the true scope of the present invention.

The present disclosure provides an information display method and a head-mounted display. At present, augmented reality technology is an emerging technology that seamlessly integrates real world information with virtual world information. Physical information, such as visual information, sound, taste, and touch, etc., that is originally difficult to experience within a certain time and space of the real world may be sensed by human senses by applying the virtual information to the real world through computer and other science and technologies for performing simulation and superimposition. Thus, the sensory experience beyond the reality may be achieved. The real environment and the virtual objects may be simultaneously superimposed in real time on a same one screen or space.

A complete augmented reality (AR) system may be implemented by collaborating a set of closely coupled, real-time working hardware components and software systems. The AR system may include a monitor-based AR, an optical perspective AR, and a video perspective AR. The hardware components commonly used in the optical perspective AR may include a head-mounted display (HIVID). The head-mounted display may be widely used in virtual reality system to enhance the user's visual sense of immersion.

A similar display technology, a perspective HIVID widely used in the AR system, may be used in the augmented reality technology. According to the specific realization principle, the perspective HIVID may include an optical see-through HIVID based on optical principle and a video see-through HIVID based on a video compositing technology. An optical see-through augmented reality system may have advantages of simple, high resolution, and no visual deviation, etc., and while may have disadvantages of high positioning accuracy, delay matching difficulty, narrow field of view, and high price, etc.

For a general terminal device, an area of a display area on a display screen may be limited. When the user needs to view more content, the user may need to constantly scroll up and down pages, and thus the reading efficiency may be reduced. The present disclosure employs an augmented reality display technology. The head-mounted display may be provided for detecting whether there is an input operation for switching from a first display mode to a second display mode. The first display mode may display a first display content on a display screen of a terminal device, and the second display mode may display a second display content containing at least a portion displayed through a head-mounted display. The first display content and second display content may correspond to a same source content. In the second display mode, the first display content on the display screen of the terminal device may be reworked, and the reworked first display content on the display screen of the terminal device may be viewed through the head-mounted display. The head-mounted display may be connected with the terminal device, and may perform a data transmission based on the connection. In response to detecting the input operation, the portion displayed through the head-mounted display may correspond to a virtual display content matching with the reworked first display content. The virtual display content displayed through the head-mounted display and the reworked first display content displayed on the display screen of the terminal device may together form the second display content.

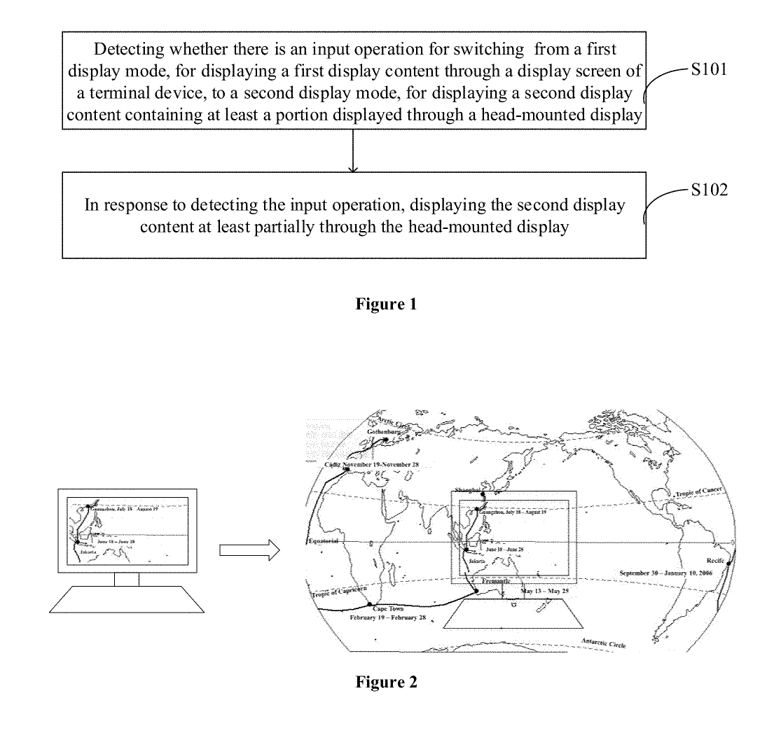

FIG. 1 illustrates a flow chart of an information display method consistent with some embodiments of the present disclosure. Referring to FIG. 1, the information display method may include the following.

In 101: Detecting whether there is an input operation for switching from a first display mode to a second display mode. The first display mode may display a first display content on a display screen of a terminal device, and the second display mode may display a second display content containing at least a portion displayed through a head-mounted display. The first display content and second display content may correspond to a same source content. In the second display mode, the first display content on the display screen of the terminal device may be reworked, and the reworked first display content on the display screen of the terminal device may be viewed through the head-mounted display. The head-mounted display may be connected to the terminal device for data transmission.

The execution subject in the present embodiment may be the head-mounted display. The head-mounted display may be connected to the display screen by one of a wired connection and a wireless connection.

The head-mounted display may detect whether there is the input operation for switching from the first display mode to the second display mode. The input operation may include a zoom-in operation, a zoom-out operation, and a page scrolling operation, etc. In response to detecting the input operation, the reworked first display content on the display screen may be viewed through the head-mounted display.

In 102: In response to detecting the input operation, displaying the second display content at least partially through the head-mounted display. In some embodiments, the virtual display content matching with the reworked first display content may be transmitted from the terminal device to the head-mounted display. Therefore, the reworked first display content on the display screen of the terminal device and the virtual display content matching with the reworked first display content may together form the second display content viewed through the head-mounted display.

In other embodiments, the reworked first display content may not be displayed on the display screen of the terminal device, and, thus, the second display content, that is, the source content may be entirely displayed through the head-mounted display.

Referring to FIG. 2, in one of application scenarios, in response to accessing a map on a computer, because an area of the map is large, the user cannot get more information in a certain zoom-in ratio. In this case, the source content may be transmitted between the computer and the head-mounted display. For example, in a case where the computer is connected to the head-mounted display, in response to detecting an event including a page scrolling of the map and a scroll wheel rolling of a mouse, the head-mounted display may obtain the entire map or the map data with a preset area to be viewed on the computer. Thus, the entire map or the map data with the preset area may be displayed through the head-mounted display. In this case, referring to FIG. 2, the reworked first display content on the display screen of the terminal device may be the same as the first display content on the display screen of the terminal device.

In response to detecting the input operation for switching from the first display mode to the second display mode, not only the reworked first display content on the display screen of the terminal device, but also the virtual display content matching with the reworked first display content may be viewed through the head-mounted display. Therefore, the display information may be enriched, and the inconvenience including a content-scrolling operation may be avoided in response to too much display content.

According to the method described in the above embodiment, the present embodiment provides more detailed specific examples. In some embodiments, in response to displaying all the obtained data by the head-mounted display, since the reworked first display content on the display screen may still be viewed through the head-mounted display, a same display content overlapping phenomenon may occur. Therefore, the head-mounted display in the present embodiment may first obtain the virtual display data matching with the reworked first display content on the display screen, may then detect a display area of the display screen, and may ultimately display the virtual display content in a preset space area surrounding the display area. The display area of the display screen may not overlap with the preset space area. Thus, the virtual display content matching with the reworked first display content and the reworked first display content on the display screen of the terminal device may be seamlessly connected and may together form a complete display content. Further, the reworked first display content and the virtual display content may together correspond to a complete display object. For example, a combination of the reworked first display content and the virtual display content may form the entire source content. The reworked first display content on the display screen of the terminal device and the virtual display content matching with the reworked first display content may be seamlessly connected and may together form the complete display object of the source content.

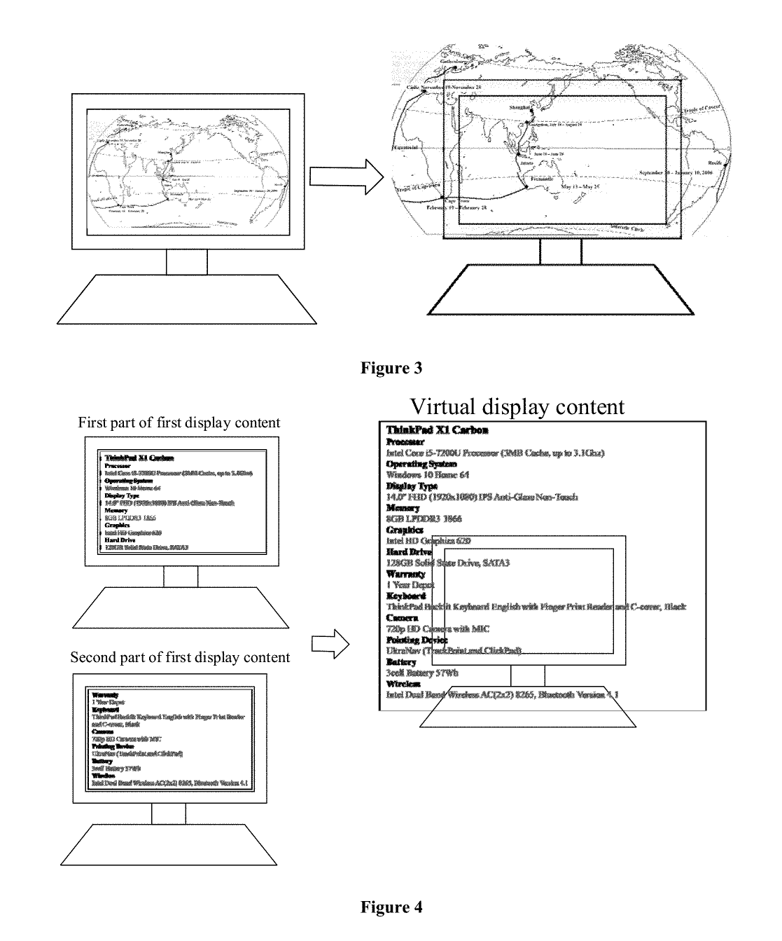

In other embodiments, referring to FIG. 3, the input operation may be a zoom-in operation, and obtaining the virtual display content matching with the reworked first display content on the display screen of the terminal device may include the following. The virtual display content may correspond to a content displayed exceeding the display area of the display screen after performing the zoom-in operation on the first display content. The head-mounted display may detect a type of the input operation. In response to detecting a zoom-in operation, the head-mounted display may first obtain the content corresponding to the first display content, and then may obtain a zoom-in ratio of the first display content. In this case, the content may be viewed in accordance with the zoom-in ratio through the head-mounted display. According to the method in the above embodiment, the virtual display content may be prevented from overlapping with the reworked first display content on the display screen (a portion of the enlarged first display content). In this case, referring to FIG. 3, the reworked first display content on the display screen of the terminal device may be a portion of the enlarged first display content on the display screen of the terminal device. The reworked first display content on the display screen of the terminal device and the virtual display content matching with the reworked first display content may be seamlessly connected and may together form the complete display object.

In other embodiments, referring to FIG. 4, the input operation may be a content-scrolling operation, and obtaining the virtual display content matching with the reworked first display content on the display screen of the terminal device may include the following. The virtual display content may correspond to a content displayed exceeding the display area of the display screen after performing the content-scrolling operation on the first display content. The content-scrolling operation may include an up and down browsing operation of a web page, a document, or a combination thereof. For example, in response to detecting an event including a scroll wheel rolling of a mouse and a page scrolling of a web page, the head-mounted display may verify that the detected event is the content-scrolling operation and may obtain the virtual display content matching with the reworked first display content on the display screen of the terminal device. In other words, the head-mounted display may obtain a first part of the first display content and a second part of the first display content after the content-scrolling operation. The reworked first display content on the display screen may be obtained by processing both the first part of the first display content and the second part of the first display content, and the virtual display content matching with the reworked first display content on the display screen may be displayed through the head-mounted display. In this case, a large amount of reading may be obtained, and the contextual reading may be more convenient. In this case, referring to FIG. 4, the reworked first display content on the display screen may be a portion of the processed first display content on the display content. The reworked first display content on the display screen of the terminal device and the virtual display content matching with the reworked first display content may be seamlessly connected and may together form the complete display object.

In response to the detected input operation for switching from the first display mode to the second display mode, the reworked first display content on the display screen of the terminal device and the virtual display content displayed through the head-mounted display may correspond to a complete image, such that the user may have a good viewing experience.

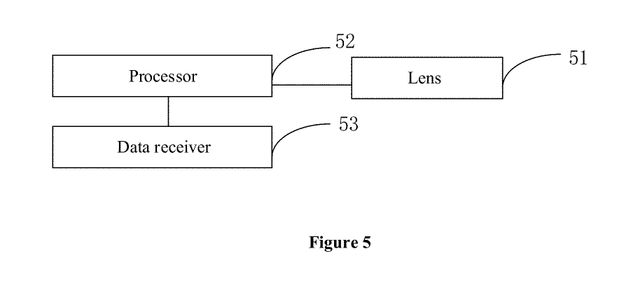

FIG. 5 illustrates a schematic diagram of a head-mounted display consistent with some embodiments of the present disclosure. Referring to FIG. 5, the head-mounted display may include a lens 51, a processor 52, and a data receiver 53.

The processor may detect whether there is an input operation for switching from a first display mode to a second display mode. The first display mode may display a first display content on a display screen of a terminal device, and the second display mode may display a second display content containing at least a portion displayed through a head-mounted display. The first display content and second display content may correspond to a same source content. In the second display mode, the first display content on the display screen of the terminal device may be reworked, and the reworked first display content on the display screen of the terminal device may be viewed through the head-mounted display. In response to detecting the input operation, the portion displayed through the head-mounted display may correspond to a virtual display content matching with the reworked first display content. The lens may be configured to view the second display content in response to the second display mode. The data receiver may be configured to receive the source content from the terminal device in response to the processor detecting the input operation. Therefore, the reworked first display content on the display screen of the terminal device and the virtual display content matching with the reworked first display content may together form the second display content to be viewed through the head-mounted display.

The processor may be realized through software functional components, and may be sold and used as independent product, the integrated components may be stored on computer readable storage media. Based on this understanding, all or a part of the generic principles or the scope of the invention may be embodied in software products. The computer software products may be stored in storage media and may include a plurality of commands to instruct a computer system (such as personal computer, server, network system, etc.) to execute all or a part of the procedures described in various embodiments consistent with the present disclosure. The storage media may include U disk, mobile hard disk, read-only memory (ROM), random access memory (RAM), magnetic disk, optical disk, or any other appropriate media that can be used to store program code.

In some embodiments, the processor may obtain the virtual display content matching with the reworked first display content, and may detect a display area of the display screen. The processor may display the virtual display content in a preset space area surrounding the display area. The display area may not overlap with the preset space area. The reworked first display content on the display screen of the terminal device and the virtual display content may together correspond to a complete display object.

In other embodiments, the input operation may be a zoom-in operation. The virtual display content may correspond to a content displayed exceeding the display area of the display screen after performing the zoom-in operation on the first display content.

In other embodiments, the input operation may be a content-scrolling operation. The virtual display content may correspond to a content displayed exceeding the display area of the display screen after performing the content-scrolling operation on the first display content.

In the present disclosure, in response to detecting the input operation for switching from the first display mode to the second display mode, not only the reworked first display content on the display screen of the terminal device, but also the virtual display content matching with the reworked first display content may be viewed through the head-mounted display. Therefore, the display information may be enriched, and the inconvenience including a content-scrolling operation may be avoided in response to too much display content.

The present disclosure also provides a terminal device. The terminal device may include a display screen, a processor, and a data transmitter. The processor may be configured to detect an input operation for switching from a first display mode, for displaying a first display content through a display screen of a terminal device, to a second display mode, for displaying a second display content containing at least a portion displayed through a head-mounted display. The first display content and second display content may correspond to a same source content. The data transmitter may be configured to transmit the source content to the head-mounted display, in response to the processor detecting the input operation. The head-mounted display may be connected to the display screen by one of a wired connection and a wireless connection.

The device and method described in the above embodiments may be realized through other approaches. That is, the description on the methods and devices in the above embodiments may only be schematic examples.

For example, multiple components may be combined together or be integrated into another system, or some features may be ignored or may not be executed. Moreover, the coupling between the components illustrated or discussed above may be direct coupling or communication connections through some indirect coupling or communication connections between interfaces, devices, or components. The coupling may be electrical, mechanical, or in any other appropriate form. The components described separately above, may or may not be physically separated. Moreover, based on the needs of actual applications, all or a part of the components may be used to realize the methods consistent with some embodiments of the present disclosure.

Further, various functional components discussed in the disclosed embodiments may be integrated in a single processing components or may be physically independent from each other. In addition, a plurality of components formed by integrating two or more than two functional components together may further form a processing component. The integrated components described above may be realized through hardware or through software functional components.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An information display method, comprising:
detecting an input operation for switching from a first display mode, for displaying a first display content through a display screen of a terminal device, to a second display mode, for displaying a second display content containing at least a portion displayed through a head-mounted display,
wherein the first display content and second display content correspond to a same source content; and
responsive to detecting the input operation, displaying the second display content at least partially through the head-mounted display.

2. The method according to claim 1, wherein:
in the second display mode, the second display content is entirely displayed through the head-mounted display, responsive to detecting the input operation.

3. The method according to claim 1, further including:
obtaining a reworked first display content responsive to the input operation based on the first display content;
obtaining a virtual display content matching with the reworked first display content;
detecting a display area of the display screen for displaying the reworked first display content; and
displaying the virtual display content through the head-mounted display in a preset space area surrounding the display area of the display screen.

4. The method according to claim 3, wherein:
the display area is non-overlapped with the preset space area, and
the reworked first display content and the virtual display content together correspond to the source content.

5. The method according to claim 3, wherein:
the input operation is a zoom-in operation; and
the virtual display content corresponds to a content displayed exceeding the display area of the display screen for displaying the reworked first display content, after performing the zoom-in operation on the first display content.

6. The method according to claim 5, wherein:
in response to the detected zoom-in operation, the head-mounted display obtains a content corresponding to the first display content, and obtains a zoom-in ratio of the first display content; and
the content is displayed in accordance with the zoom-in ratio through the head-mounted display.

7. The method according to claim 3, wherein:
the input operation is a content-scrolling operation; and
the virtual display content corresponds to a content displayed exceeding the display area of the display screen for displaying the reworked first display content, after performing the content-scrolling operation on the first display content.

8. The method according to claim 7, wherein:
the content-scrolling operation includes an up and down browsing operation of a web page, a document, or a combination thereof

9. The method according to claim 3, wherein:
in response to detecting an event including a scroll wheel rolling of a mouse and a page scrolling of a web page, the head-mounted display obtains a first part of the first display content and a second part of the first display content after the content-scrolling operation;
the reworked first display content is obtained by processing both the first part of the first display content and the second part of the first display content, and is viewed through the head-mounted display; and
the virtual display content matching with the reworked first display content is displayed through the head-mounted display.

10. The method according to claim 3, wherein:
the data transmission between the terminal device and the head-mounted display includes transmitting display data corresponding to the reworked first display content.

11. A head-mounted display, comprising:
a processor, configured to detect an input operation for switching from a first display mode, for displaying a first display content through a display screen of a terminal device, to a second display mode, for displaying a second display content containing at least a portion displayed through the head-mounted display, wherein the first display content and second display content correspond to a same source content;
a data receiver, configured to receive the source content from the terminal device, in response to the processor detecting the input operation; and
a lens, configured to view at least the portion of the second display content, in the second display mode.

12. The head-mounted display according to claim 11, wherein:
the input operation includes one of a zoom-in operation, a zoom-out operation, and a content-scrolling operation.

13. The head-mounted display according to claim 11, wherein:
in the second display mode, the second display content is entirely displayed through the head-mounted display, responsive to detecting the input operation.

14. The head-mounted display according to claim 11, wherein the processor:
obtains a reworked first display content responsive to the input operation based on the first display content;
obtains a virtual display content matching with the reworked first display content;
detects a display area of the display screen for displaying the reworked first display content; and
displays the virtual display content through the head-mounted display in a preset space area surrounding the display area of the display screen.

15. The head-mounted display according to claim 14, wherein:
the display area is non-overlapped with the preset space area, and
the reworked first display content and the virtual display content together correspond to the source content.

16. The head-mounted display according to claim 14, wherein:
the input operation is a zoom-in operation; and
the virtual display content corresponds to a content displayed exceeding the display area of the display screen for displaying the reworked first display content, after the zoom-in operation on the first display content.

17. The head-mounted display according to claim 14, wherein:
the input operation is a content-scrolling operation; and
the virtual display data corresponds to a content displayed exceeding the display area of the display screen for displaying the reworked first display content, after the content-scrolling operation on the first display content.

18. The head-mounted display according to claim 17, wherein:
the content-scrolling operation includes an up and down browsing operation of a web page, a document, or a combination thereof

19. A terminal device, comprising:
a display screen;
a processor, configured to detect an input operation for switching from a first display mode, for displaying a first display content through the display screen, to a second display mode, for displaying a second display content containing at least a portion displayed through a head-mounted display, wherein the first display content and second display content correspond to a same source content; and
a data transmitter, configured to transmit the source content to the head-mounted display, in response to the processor detecting the input operation.

20. The terminal device according to claim 19, wherein:
in the second display mode, the second display content is displayed through the head-mounted display or through a combination of the head-mounted display and the terminal device.
